(19) United States
(12) Patent Application Publication
(10) Pub. No.: US 2010/0255335 A1
(43) Pub. Date: Oct. 7, 2010

(54) Configuration of and welding procedures applied to cruet shaped bevels in objects to be welded

(75) Inventors: Antonio Belloni, Codogno (IT); Ramiro Angel Cortes Guzman, Houston, TX (US)

Correspondence Address: GABLE & GOTWALS, 100 WEST FIFTH STREET, 10TH FLOOR, TULSA, OK, 74103, US

(73) Assignee: CRC-Evans Pipeline International, Inc.

(21) Appl. No.: 12/384,593

(22) Filed: Apr. 7, 2009

(51) Int. Cl. B32B 15/01; B23K 9/00

(52) U.S. Cl. 428/615; 219/137 R

(57) ABSTRACT

Metallic objects such as steel pipes and shipbuilding plates are welded using complemental bevels in the faces to be welded which, when abutted, define a channel of cruet shaped cross-section. The cruet shaped channel allows the filling weld passes to be performed using a welding instrument oscillated only at tolerance amplitudes in a range of 1.5 mm±0.5 mm rather than bevel width amplitudes. The process can be used in single or double side welding applications.

### BACKGROUND OF THE INVENTION

This invention relates generally to the joining of metallic objects such as steel pipes and plates and more particularly concerns the configurations of and the welding procedures applied to the objects being joined.

There are some long-standing and well known problems in the welding processes used for fusing steel pipes and plates, or any metallic objects. Known systems generally operate at medium or high heat input and cause distortion of the welded objects. Welding speeds are relatively low, particularly in conventional “open” bevel welding applications. Open bevel welding typically requires welding instrument oscillation because the bevel side walls diverge over the entire depth of the bevel from the root to the last fill passes. Unfortunately, every incremental increase in bevel width results in an incremental increase in oscillation amplitude results in an incremental increase in weld time. And deeper bevels require a greater number of incremental increases. Looking at FIG. 1, an average V-shaped bevel might reasonably be expected to have a 5 mm root width R, a 10 mm cap width C and a 25 mm depth D. If 1 mm filler wire were used, such a weld would require a minimum 1.5 mm oscillation amplitude at the root pass Pᵣ and a maximum 6.5 mm oscillation amplitude at the cap pass P_{c}. The difference of 5 mm would be accounted for in approximately four intermediate passes Pᵢ at 1 mm incremental increases. But, since more filler wire must be deposited at each level, the travel speed of the weld instrument must be reduced and each weld pass takes increasingly longer. Increases in weld time have a proportionately adverse impact on the efficiency of the welding process and the quality of the weld. Furthermore, for objects with greater wall thicknesses, perhaps in a range of 20 mm to 40 mm, a very precise verticality of the welding instrument and a very precise straightness of the welding wire is required in order to avoid contact between the welding instrument tip and the bevel side walls. These conditions are very difficult to achieve using known welding practices and every welding-instrument-to-bevel-wall contact carries its own potentially adverse impact on the efficiency of the welding process and the quality of the weld.

Recently, a new welding procedure has been developed for girth welding metallic pipes into pipelines carrying oil, gas and water. According to the new procedure, and as seen in FIGS. 2 and 3, the weld bevel has a cruet shaped cross-section S. The side walls of the cruet body extend at a 3° angle Φ from vertical. The cruet neck N has either parallel side walls Wₚ extending from the mouth M, as seen in FIG. 2, or slightly converging side walls W_{c} narrowing from the mouth M in the direction of the cruet body B, as seen in FIG. 3. The angles θ made by the walls W_{c} of the neck N with vertical are less than 3°. For shallow bevels, the less-than-3° angles θ result in the neck N being not wider than the cruet body B. The shallower the bevel, the less width variation occurs over the converging portion W_{c} of the cruet neck N. The maximum difference Δ₁+Δ₂ in width over the depth D of the bevel is less than 1 mm, eliminating the need for width-compensating oscillation. Therefore, use of the cruet shaped bevel typically cuts welding time in half. However, the thicker walled the objects, the more difficult, if not impossible, it becomes to achieve a quality weld, even with these cruet shapes.

It is, therefore, an object of this invention to provide a welding bevel configuration and process which consistently result in quality welds in reasonable time. A further object of this invention is to provide a welding bevel configuration and process which eliminates the need for width-compensating oscillation. It is also an object of this invention to provide a welding bevel configuration and process which are useful in welding a variety of thin and thick walled objects including steel pipes and shipbuilding plates. Another object of this invention is to provide a welding bevel configuration and process which can be used in single and double side weld applications.

### SUMMARY OF THE INVENTION

In accordance with the invention, several new concepts are hereby introduced into the cruet shaped bevel technology, including tolerance-compensating oscillation, unique cruet neck configurations and combining these concepts in a double sided welding procedure.

First of all, in the concept of tolerance-compensating oscillation, the welding instrument is oscillated from the root pass to the last fill passes, but only in a narrow range of 1.5±0.5 mm. This limited and substantially constant oscillation improves weld quality because it compensates for joint gap variations resulting from bevel machine tolerances and gap variations between abutted faces of the objects to be welded. The conventional open bevel practice of incremental increases in width-compensating oscillation is still avoided. The use of tolerance-compensating oscillation does not significantly vary the weld time from pass to pass.

Secondly, in the unique cruet neck configurations, a 3° to 5° converging angle of the neck portion of the bevel side walls with respect to their longitudinal axis of symmetry can be employed for shallower cruet shaped bevel depths. Furthermore, the 3° to 5° angle can be used for deeper cruet shaped bevel depths if it is restricted to the upper portion of the cruet neck. These unique contours of the bevel allow the cruet shaped bevel technology to be used to provide quicker and higher quality welds in even thicker objects than can be achieved using non-cruet shaped bevel technology.

Thirdly, the cruet shaped bevel technology can be applied in a double side welding procedure so as to further reduce weld time and/or increase object thickness. The double side weld concept can be applied to any acceptable cruet shaped bevel within the scope of this disclosure.

In applying the new method for welding juxtaposed faces of metallic objects existing cruet shaped bevel welding technology, the complemental bevels provided in the faces to be welded, when abutted, define a channel of cruet shaped cross-section having an open mouth and a neck extending from the mouth to a widening body in accordance with past practice. The channel is filled with a plurality of sequential weld passes. In each weld pass, a filler wire is deposited through the mouth to the furthest unfilled level in the channel. However, the deposited wire is then melted using an oscillated welding instrument, preferably with an oscillation amplitude in a range of 1.5 mm±0.5 mm.

In the new cruet shaped bevel configurations, the complemental bevels in the faces to be joined, when abutted, define a channel of cruet shaped cross-section with an open mouth, a neck and a widening body. The open mouth is located in a surface formed by non-abutting surfaces of the objects. The neck extends from the mouth to the body. The cruet shaped cross-section is symmetrical about its longitudinal axis which extends from its mouth to the closed end of the body. The body has side walls which diverge from their respective neck walls at an angle in relation to the longitudinal axis of approximately 3°. A plurality of weld passes fill the channel. The neck may have parallel side walls or side walls which converge from the mouth at an angle in relation to the longitudinal axis in a range of 3°-5°. Preferably for thick walled objects, the neck converges to approximately a longitudinal midpoint of the cruet-shaped cross-section and then extends in parallel to the body.

For double side welding, second complemental bevels in the faces to be joined, when abutted, define a second channel of cruet shaped cross-section. The second channel cross-section has an open mouth located in another surface formed by other non-abutting surfaces of the objects and a neck extending from the mouth to a widening body. The cruet shaped cross-section of said second channel is symmetrical about the same longitudinal axis as the first. The body of the second channel has side walls which diverge from their respective walls of their neck at an angle in relation to the longitudinal axis of approximately 3°-5°. The bodies of both channels have closed ends spaced apart by the abutting faces of the objects. A plurality of weld passes fill the second channel. The neck of said second channel may have parallel side walls or side walls which converge from the mouth of the second channel at an angle in relation to the longitudinal axis in a range of 3°-5°. Preferably for thick walled objects, the neck converges to approximately a longitudinal midpoint of the cruet-shaped cross-section of the second channel and then extends in parallel to the body of the second channel. Preferably, the second channel cross-section is an inverted image of the first channel cross-section in relation to an axis transverse to the longitudinal axis.

Using the new cruet shaped bevel configurations with the new cruet shaped bevel welding method, in each weld pass a filler wire is deposited through the mouth to the furthest unfilled level in the channel and the deposited wire is then melted using an oscillated welding instrument, preferably with an oscillation amplitude in a range of 1.5 mm±0.5 mm. The method is applicable to both single and double side welding applications.

### BRIEF DESCRIPTION OF THE DRAWINGS

Other objects and advantages of the invention will become apparent upon reading the following detailed description and upon reference to the drawings in which:

FIG. 1 is a cross-sectional view illustrating prior art welding instrument width compensating oscillation in a conventional open bevel weld;

FIG. 2 is a cross-sectional view illustrating a first cruet shaped bevel contoured as in the prior art and which can be used with the welding method of the present invention;

FIG. 3 is a cross-sectional view illustrating a second cruet shaped bevel contoured as in the prior art and which can be used with the welding method of the present invention;

FIG. 4 is a cross-sectional view illustrating a third cruet shaped bevel contoured according to the present invention and which can be used with the welding method of the present invention;

FIG. 5 is a cross-sectional view illustrating a fourth cruet shaped bevel contoured according to the present invention and which can be used with the welding method of the present invention;

FIG. 6 is a cross-sectional view illustrating the cruet shaped bevel of FIG. 5 in a double weld application;

FIG. 7 is a cross-sectional view illustrating the cruet shaped bevel of FIG. 5 partially filled by a root weld pass and a hot weld pass according to the principles of the present invention;

FIG. 8 is a cross-sectional view illustrating the cruet shaped bevel of FIG. 5 with the cruet body filled by weld passes according to the principles of the present invention;

FIG. 9 is a cross-sectional view illustrating the cruet shaped bevel of FIG. 5 with the diverging wall portion of the cruet neck filled by weld passes according to the principles of the present invention; and

FIG. 10 is a cross-sectional view illustrating the cruet shaped bevel of FIG. 5 with the cruet mouth filled and capped by final weld passes according to the principles of the present invention.

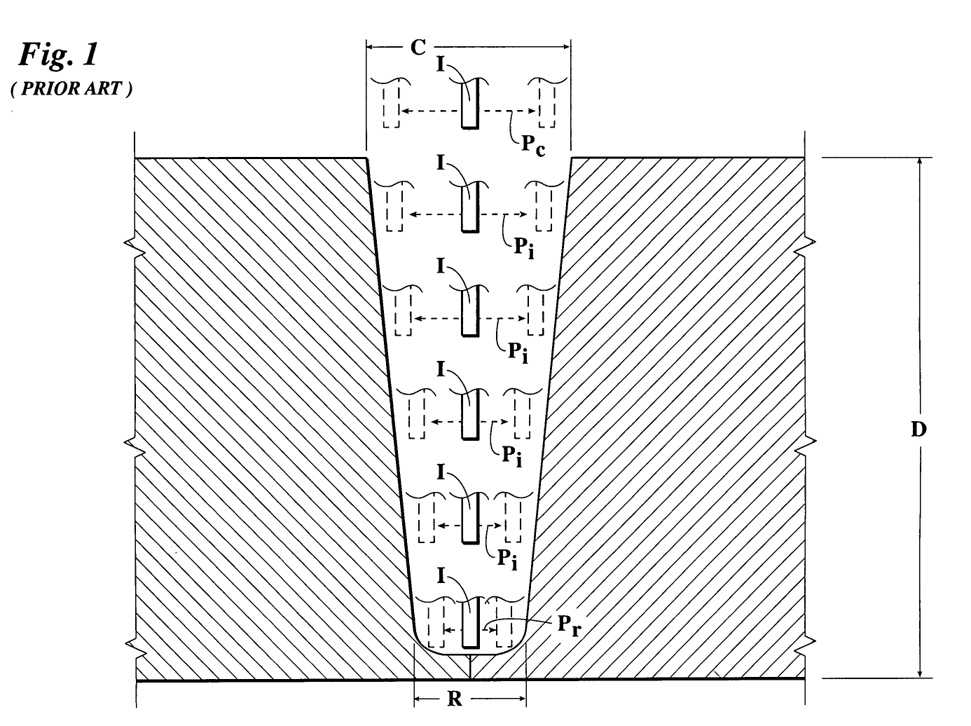

While the invention will be described in conjunction with preferred embodiments thereof, it will be understood that it is not intended to limit the invention to those embodiments or to the details of the construction or arrangement of parts illustrated in the accompanying drawings.

### DETAILED DESCRIPTION

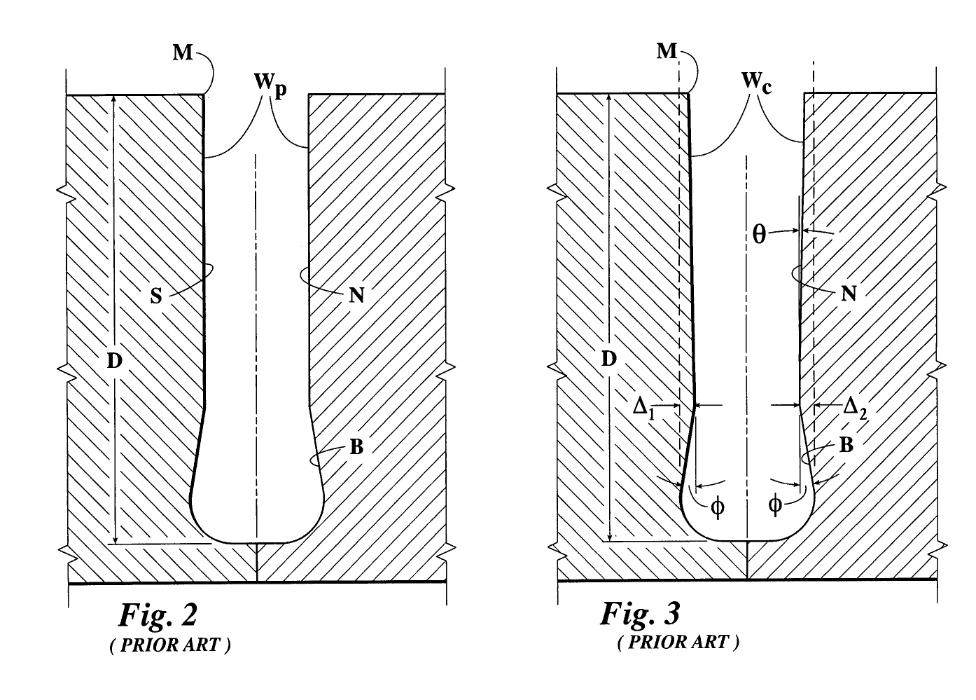

Looking again at the prior art cruet shaped bevels of FIGS. 2 and 3, in accordance with the method of the present invention, the bevels will be filled from the root pass to the last fill passes but, unlike prior cruet shaped bevel technology, with oscillation of the welding instrument. However, the oscillation is limited to a narrow range of 1.5±0.5 mm. This limited and substantially constant oscillation improves weld quality because it compensates for joint gap variations resulting from bevel machine tolerances and gap variations. However, despite the oscillation, no change in the speed of travel of the weld instrument between the abutted faces of the objects to be welded is required. The entire weld is performed without significant variation in the weld time expended from pass to pass. The total weld time is reduced to half the time taken for conventional open bevel welds of comparable objects. Moreover, using the cruet bevel tolerance-compensating oscillation of the present invention, the quality of the weld is more consistently maintained than with either conventional width compensating oscillation or with non-oscillated cruet shaped welds, even for thicker objects.

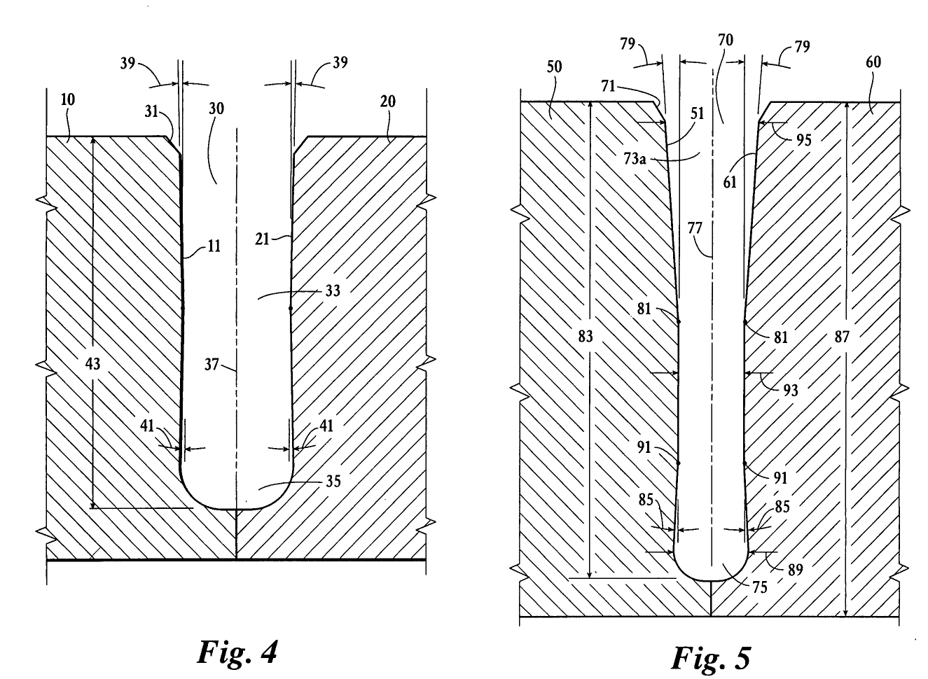

Turning to FIG. 4, for two objects 10 and 20, complemental bevels 11 and 21 are provided in the faces to be welded. The bevels 11 and 21, when abutted, define a channel 30 of cruet shaped cross-section having an open mouth 31 and a neck 33 extending from the mouth 31 to a widening body 35. The mouth 31 may be outwardly tapered from the neck 33, as shown in FIG. 4, or be the open end M of the neck N as seen in FIGS. 2 and 3, without negative impact on the cruet shaped bevel technology. The cruet channel 30 is symmetrical about its longitudinal axis 37 which extends from its mouth 31 to the closed end of the body 35. A 3° to 5° converging angle 39 of the side walls of the cruet neck 33 with respect to their longitudinal axis of symmetry 37 can be employed while maintaining the limited oscillation within the narrow range of 1.5±0.5 mm. This can be achieved as long as the widest width of the neck 33 is approximately less than 1 mm wider than the widest width of the body 35 of the cruet channel 30. As shown, the neck 33 of the cruet channel 30 converges from the cruet mouth 31 to the cruet body 35 at an angle 39 of 3° to 5° and the side walls of the body 35 then diverge from the side walls of the cruet neck 33 at an angle 41 of 3°. This contour of the cruet channel 30 can be employed for shallower cruet shaped bevel depths 43.

As seen in FIG. 5, showing two objects 50 and 60 of greater thickness than seen in FIG. 4, the complemental bevels 51 and 61 form the cruet channel 70. The cruet channel 70 has a tapered mouth 71, a neck 73 and a body 75. However, the neck convergence is restricted to the upper portion 73a of the cruet neck 73. The cruet channel 70 is symmetrical about its longitudinal axis 77. The angle of convergance 79 of the upper portion 73a of the neck 73, taken in relation to the longitudinal axis 77, is 3° to 5° from the cruet mouth 71 to approximately a mid-portion 81 of the bevel depth 83. The lower portion 73b of the neck 73 extends in parallel from the upper portion 73a of the neck 73 to the cruet body 75. The walls of the body 75 then diverge from the walls of the cruet neck 73 at angles 85 of 3°. The particular shape of this channel 70 in any given application is arrived at in several steps. For example, for welding objects with mating walls up to 40 mm thick 87, a preferred cruet body 75 will, at its widest level 89, be approximately 5.8 mm wide. The parallel portion 73b of the cruet neck 73 will be approximately 5.5 mm wide. The 3° angled walls of the cruet body 75 are extended from the cruet mouth 71 to their intersection 91 with the parallel walls of the cruet neck 73. In this example, there is a difference of approximately 0.3 mm from greatest cruet body width 89 to the width 93 of the parallel portion 73b of the cruet neck 73. In any variation from the above dimensions, the difference between the greatest cruet body width and the parallel walls of the cruet neck should be maintained in a range of 0.3 to 1.0 mm. The parallel portion 73b of the cruet neck 73 extends from the cruet body 75 to approximately the mid-portion 81 of the bevel depth 87 where it intersects with the 3° to 5° walls of the converging portion 73a of the cruet neck 73. The wall angles 79 for the converging portion 73a of the cruet channel 70 may be anywhere in the 3° to 5° range as long as the widest width 95 of the neck 73 does not so significantly exceed the widest width 89 of the body 75 that oscillation cannot be limited to a range of 1.5 mm±0.5 mm.

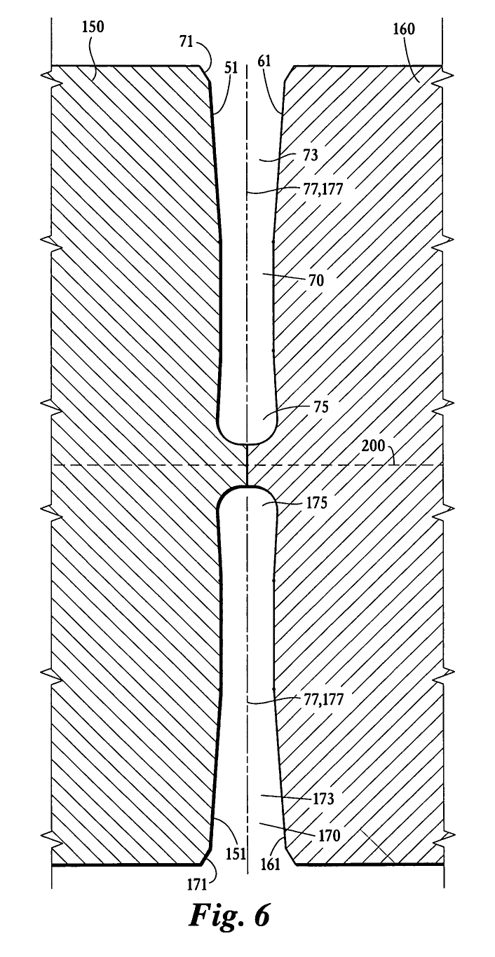

The cruet shaped bevel technology can be applied in a double side welding procedure so as to further reduce weld time and/or increase object thickness. Looking at FIG. 6, the cruet shaped channel 70 illustrated in FIG. 5 is used to illustrate the double side welding application. In FIG. 6, the first channel 70 is as illustrated in FIG. 5. For double side welding, second complemental bevels 151 and 161, when abutted, define a second channel 170 of cruet shaped cross-section having an open mouth 171 and a neck 173 extending from the mouth 171 to a widening body 175. The second channel 170 is symmetrical about the same longitudinal axis 77, 177 as the first channel 70. As shown, the first and second complemental bevels 151 and 161 are also configured in the contour of FIG. 5, preferably with the cross-section of the second channel 170 being an inverted image of the cross-section of the first channel 70 in relation to an axis 200 transverse to the longitudinal axis 77, 177. However, any of the contours of FIGS. 2-5 could be used for double sided welding and they need not be identical as long as they are of acceptable cruet shape bevel contours in keeping with limitations herein disclosed for such bevels.

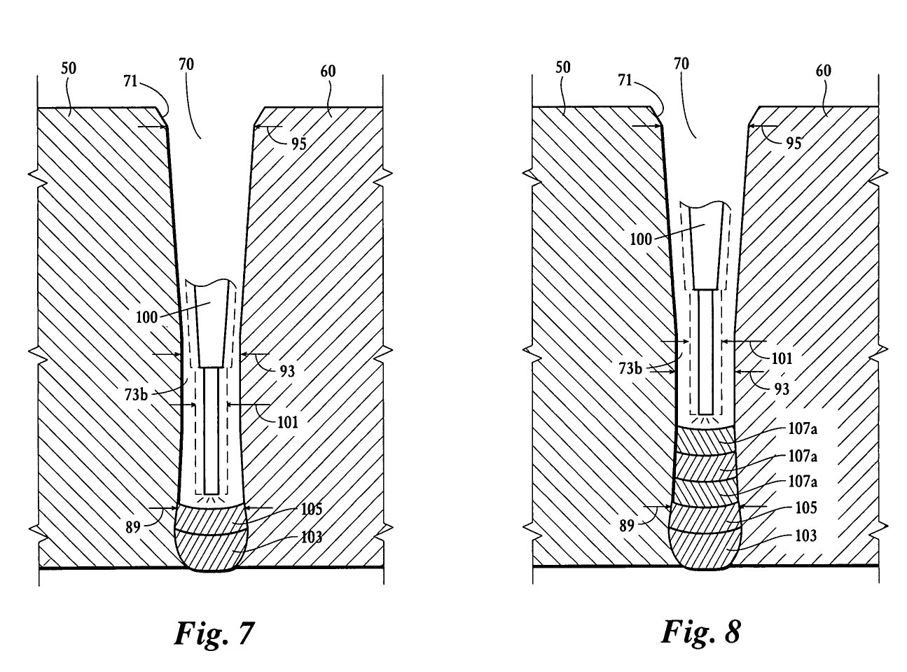

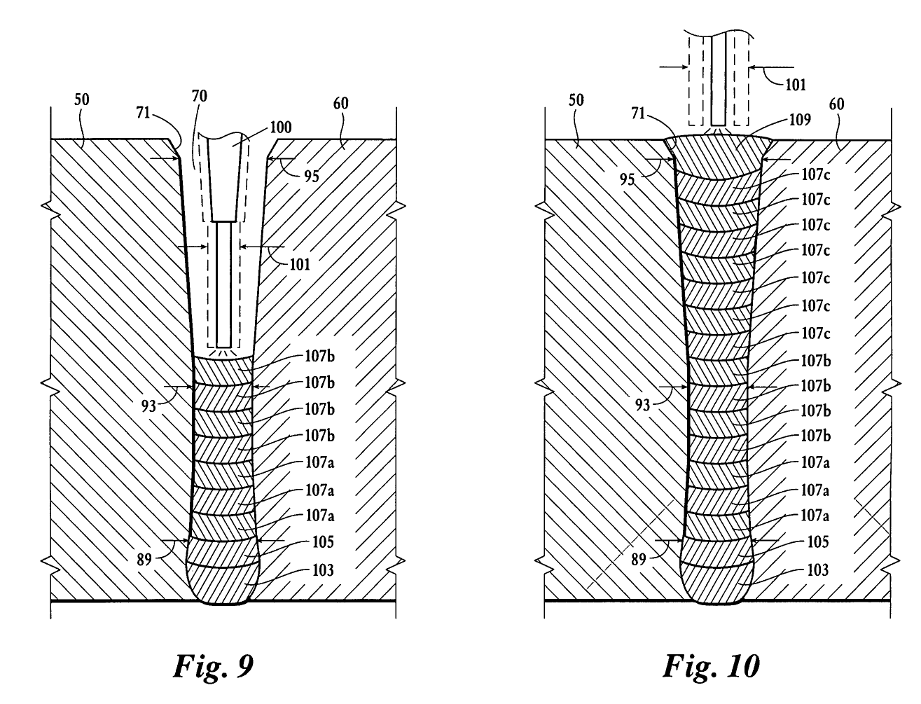

Looking at FIGS. 7-10, the cruet shaped bevel technology oscillating welding instrument method is illustrated with respect to a single channel 70 contoured as shown in FIG. 5. The channel 70 is filled with a plurality of sequential weld passes. In each weld pass, a filler wire deposited through the cruet mouth 71 to the furthest unfilled level in the channel 70 is melted using an oscillated welding instrument 100, preferably with an oscillation amplitude 101 in a range of 1.5 mm±0.5 mm. As seen in FIG. 7, the cruet body 75 has been partially filled by a root pass 103 which has melted and fully penetrated through the objects 50 and 60 and a hot pass 105. The welding instrument oscillations 101 are held within the non-contact limits of the narrowest width 93 of the channel 70 which, as shown, is determined by the parallel walls of the lower portion 73b of the cruet neck 73. Since the dimensions of the channel 70 have been chosen in accordance with cruet shaped bevel technology, these tolerance compensating oscillations 101 permit a quality weld to be completed in the widest width 89 of the cruet body 75. As seen in FIG. 8, additional passes 107a have filled the cruet body 75 and oscillation 101 is still held within the non-contact limits of the parallel portion 73b of the cruet neck 73. Looking at FIG. 9, when the parallel portion 73b of the cruet neck 73 has been filled by additional passes 107b, the width of the of the upper portion 73a of the cruet neck 73 increases as the weld passes are completed. However, the oscillation 101 can still be maintained because the maximum width 95 of the cruet neck 73 is not significantly greater than the maximum width 89 of the cruet body 75. As seen in FIG. 10, the weld has been completed with the mouth filled and capped by final weld passes 107c and 109.

The cruet shaped bevel technology has a direct impact on construction costs. Welding can be accomplished at a rate of 30 to 60 inches per minute with deposition ranging from 3 to 6 mm per run using single or twin welding instruments, respectively. Due to the low heat input of the process, in the order of 0.5 Kj/mm, welded object distortion is reduced and the heat affected zone of the welded object is reduced in size and maintains better mechanical properties than those obtained with medium/high heat input welding systems. The cruet shaped bevel technology is applicable to arcuately surfaced objects such as steel pipes and to flat objects such as metallic plates used in ship-building. It can be used for single side or double side welding. It can be applied using filler wire of various diameters, including 1.0, 1.2, 1.4, 1.6 and 2.0 mm filler wire. It allows use of a welding instrument with a reduced width contact tip, enabling use of a constant width welding instrument oscillation in narrow as well as broader bevel widths.

Thus it is apparent that there has been provided, in accordance with the invention, a welding bevel and process that fully satisfies the objects, aims and advantages set forth above. While the invention has been described in conjunction with specific embodiments thereof, it is evident that many alternatives, modifications and variations will be apparent to those skilled in the art and in light of the foregoing description. Accordingly, it is intended to embrace all such alternatives, modifications and variations as fall within the spirit of the appended claims.

What is claimed is:

1. A method for welding juxtaposed faces of metallic objects comprising the steps of:
providing complemental bevels in the faces to be welded, the complemental bevels when abutted defining a channel of cruet shaped cross-section having an open mouth and a neck extending from the mouth to a widening body; and
filling the channel with a plurality of sequential weld passes, each weld pass comprising the steps of;
depositing a filler wire through the mouth to the furthest unfilled level in the channel; and
melting the deposited wire with an oscillated welding instrument.

2. A method according to claim 1, the oscillations having an amplitude in a range of 1.5 millimeters±0.5 millimeters.

3. A junction of abutting faces of two metallic objects comprising:
complemental bevels in the faces to be joined, said complemental bevels when abutted defining a channel of cruet shaped cross-section having an open mouth located in a surface formed by non-abutting surfaces of said objects and a neck extending from said mouth to a widening body, said cruet shaped cross-section being symmetrical about a longitudinal axis extending from said mouth to a closed end of said body, said body having side walls diverging from their respective walls of said neck at an angle in relation to said longitudinal axis in a range of 3°-5°; and
a plurality of weld passes filling said channel.

4. A junction according to claim 3, said neck having parallel side walls.

5. A junction according to claim 3, said neck having side walls converging from said mouth at an angle in relation to said longitudinal axis in a range of 3°-5°.

6. A junction according to claim 5, said neck converging to approximately a longitudinal midpoint of said cruet-shaped cross-section and extending in parallel therefrom to said body.

7. A junction according to claim 3 further comprising:
second complemental bevels in the faces to be joined, said second complemental bevels when abutted defining a second channel of cruet shaped cross-section having an open mouth located in another surface formed by other non-abutting surfaces of said objects and a neck extending from said mouth to a widening body, said cruet shaped cross-section of said second channel being symmetrical about said longitudinal axis, said body of said second channel having side walls diverging from their respective walls of said neck of said second channel at an angle in relation to said longitudinal axis in a range of 3°-5°, said bodies of said channel and said second channel having closed ends thereof spaced apart by the abutting faces of the objects; and
a plurality of weld passes filling said second channel.

8. A junction according to claim 7, said neck of said second channel having parallel side walls.

9. A junction according to claim 7, said neck of said second channel having side walls converging from said mouth of said second channel at an angle in relation to said longitudinal axis in a range of 3°-5°.

10. A junction according to claim 9, said neck side walls converging to approximately a longitudinal midpoint of said cruet-shaped cross-section of said second channel and extending in parallel therefrom to said body of said second channel.

11. A junction according to claim 10, said second channel cross-section being an inverted image of said channel cross-section in relation to an axis transverse to said longitudinal axis.

12. A method for welding juxtaposed faces of metallic objects comprising the steps of:
providing complemental bevels in the faces to be welded, the complemental bevels when abutted defining a channel of cruet shaped cross-section having an open mouth located in a surface formed by non-abutting surfaces of the objects and a neck extending from the mouth to a widening body, the cruet shaped cross-section being symmetrical about a longitudinal axis extending from the mouth to a closed end of the body, the body having side walls diverging from their respective walls of the neck at an angle in relation to the longitudinal axis in a range of 3°-5°; and
filling the channel with a plurality of sequential weld passes, each weld pass comprising the steps of;
depositing a filler wire through the mouth to the furthest unfilled level in the channel; and
melting the deposited wire with an oscillated welding instrument.

13. A method according to claim 12, the oscillations having an amplitude in a range of 1.5 millimeters±0.5 millimeters.

14. A method according to claim 12, the neck having parallel side walls.

15. A method according to claim 12, the neck having side walls converging from the mouth at an angle in relation to the longitudinal axis in a range of 3°-5°.

16. A method according to claim 15, the neck converging to approximately a longitudinal midpoint of the cruet-shaped cross-section and extending in parallel therefrom to the body.

17. A method according to claim 12 further comprising:
providing second complemental bevels in the faces to be joined, the second complemental bevels when abutted defining a second channel of cruet shaped cross-section having an open mouth located in another surface formed by other non-abutting surfaces of the objects and a neck extending from the mouth to a widening body, the cruet shaped cross-section of the second channel being symmetrical about the longitudinal axis, the body of the second channel having side walls diverging from their respective walls of the neck of the second channel at an angle in relation to the longitudinal axis in a range of 3°-5°, the bodies of the channel and the second channel having closed ends thereof spaced apart by the abutting faces of the objects; and
filling the second channel with a second plurality of sequential weld passes, each weld pass of said second plurality comprising the steps of;
depositing a filler wire through the mouth of the second channel to the furthest unfilled level in the second channel; and
melting the deposited wire with an oscillated welding instrument.

18. A method according to claim 17, the oscillations of the second channel weld passes having an amplitude in a range of 1.5 millimeters±0.5 millimeters.

19. A method according to claim 17, the neck of the second channel having parallel side walls.

20. A method according to claim 17, the neck of the second channel having side walls converging from the mouth of the second channel at an angle in relation to the longitudinal axis in a range of 3°-5°.

21. A method according to claim 20, the neck of the second channel converging to approximately a longitudinal midpoint of the cruet-shaped cross-section of the second channel and extending in parallel therefrom to the body of the second channel.

22. A junction according to claim 21, the second channel cross-section being an inverted image of the channel cross-section in relation to an axis transverse to the longitudinal axis.
